(19) United States
(12) Patent Application Publication
(10) Pub. No.: US 2004/0086257 A1
(43) Pub. Date: May 6, 2004

(54) Integrated machine readable media and ticket

(76) Inventors: David K. Werberig, Victor, NY (US); Todd Knipe, Farmington, NY (US); Paul Robistow, Henrietta, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/286,310

(22) Filed: Nov. 1, 2002

(51) Int. Cl. H04N 5/76; H04N 5/781

(52) U.S. Cl. 386/46; 386/125

(57) ABSTRACT

The present invention is a device and method for an event ticket used to gain entry to an event such as a performance or exhibition including a first component that includes data for validating the right to enter and attend the event, a second component that includes a machine readable section having a static portion and a dynamic portion wherein the static portion includes read only data relevant to the event, the data being accessible pre- or post-event, and the dynamic portion including a means for allowing pre- and/or post-event communication with a browser.

### FIELD OF THE INVENTION

This invention relates generally to the integration of various types of information on a ticket and more particularly to a method and apparatus for collecting and exchanging digital and analog information in a ticket format capable of interacting with a web page via the Internet.

### BACKGROUND OF THE INVENTION

Tickets are currently used to allow a ticket holder to enter an event by giving the ticket or a portion of the ticket to the gatekeeper of the event. A consumer will normally purchase a ticket and then take this ticket to the event and present the ticket in order to gain admission. This conventional sales method is used for the purchase of an event, travel or other type of ticket. The ticket is sold when the customer goes to a ticket sales window and decides what ticket he desires to purchase. When the customer purchases the ticket it may be preprinted or printed on location. Usually the customer pays for the ticket before the event or at the ticket sales window and then attends the event.

Consumers may keep the traditional paper ticket as a memento after they leave the event. The event entry and associated memories are the extent of the usefulness of this traditional ticket. The consumer may then paste the ticket in a scrapbook or store the ticket someplace and will not refer to it again. The traditional ticket represents a lost opportunity for direct marketing.

There is a need for a method and apparatus for integrating machine readable media, such as tickets, for events that can serve a dual purpose of event entry and pre and post event communication through the Internet with event induced or connected web pages.

### SUMMARY OF THE INVENTION

The present invention is a system and method for an event ticket used to gain entry to an event, such as a performance, a sports competition or an exhibition. The ticket has data for validating the right to enter and attend the event and a first component and a second component that includes a machine-readable section having a dynamic portion and a static portion. The static portion includes read only data relevant to the event, the data being accessible pre- or post-event. The dynamic portion includes a means for allowing pre- and/or post-event communication with other communication devices such as an intranet, the Internet via a browser, and a telephone or telephone-like device.

### BRIEF DESCRIPTION OF THE DRAWINGS

FIGS. 1a and 1b show an event ticket from the front and back.

FIG. 2 depicts a functional block diagram of consumer buying and using a ticket.

FIG. 3 depicts a functional block diagram of consumer using a machine readable event ticket.

FIGS. 4a-4k show different formats for the event ticket.

FIGS. 5a and 5b depict two types of web pages.

FIG. 6 depicts a block diagram of the use of the present invention.

FIG. 7 depicts another block diagram of the use of the present invention.

### DETAILED DESCRIPTION OF THE PREFERRED EMBODIMENT

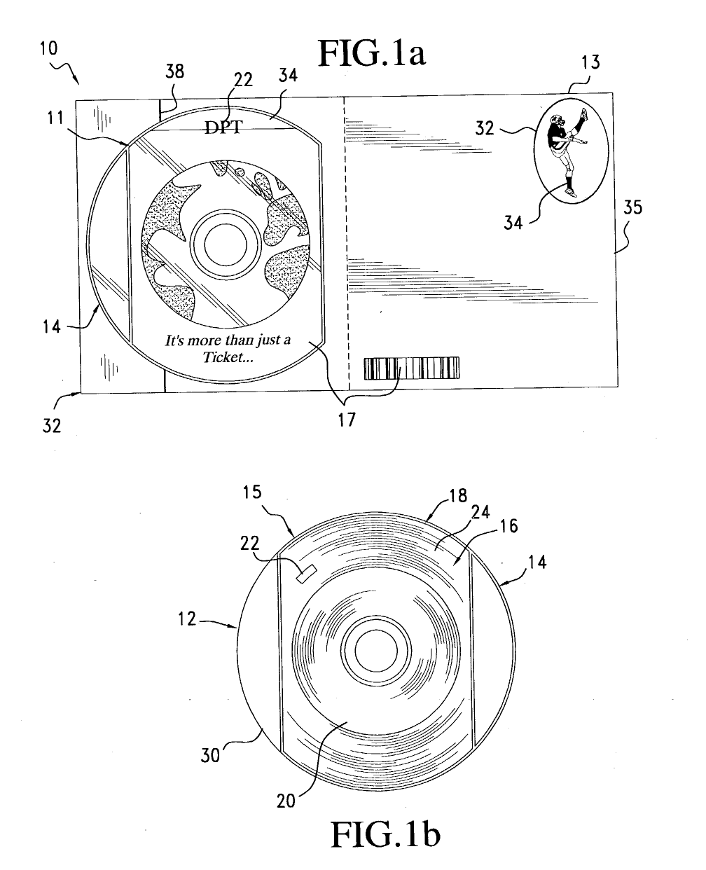

A machine-readable medium, referred to hereafter as an event ticket 10, as shown in FIG. 1, integrates different types of information such as digital and analog information. The event ticket 10 is used to gain entry to an event, such as a performance, sports competition, or exhibition. The event ticket 10 has a front 11 or first side and back 12 or second side, and can include a ticket case 13 as shown in FIG. 1a.

The event ticket 10 has validating data 17 that grants the event ticket 10 holder the right to attend the event. The event ticket 10 also has a first component 14 that may contain the validating data. The event ticket 10 might alternatively be used to gain access to the event via an electronic means such as through the Internet for an on-line performance or on pay-for-view events. The first component 14 can be a separable portion such as a tab, the ticket case 13 for holding a portion or all of the rest of the event ticket 10, readable indicia such as a barcode as well as other machine readable formats that will be discussed in more detail below. The validating data 17 and other information is placed on the event ticket 10. The information can be printed or placed on the front 11 or back 12 of the event ticket 10, including on the ticket case 13 if there is one. This information can take a variety of forms such as audio, olfactory, or visual including holograms.

The event ticket 10 has a second component 15 shown in FIG. 1b that includes a machine readable section 16 having a static portion 18 and a dynamic portion 20. The static portion 18 includes content that is fixed relative to the ticket 10, and does not or is not changed or is not changeable. The dynamic portion 20 can include static content that allows access to changeable content but also includes modifiable data or capacity to acquire and retain machine readable information after the event ticket 10 has been produced.

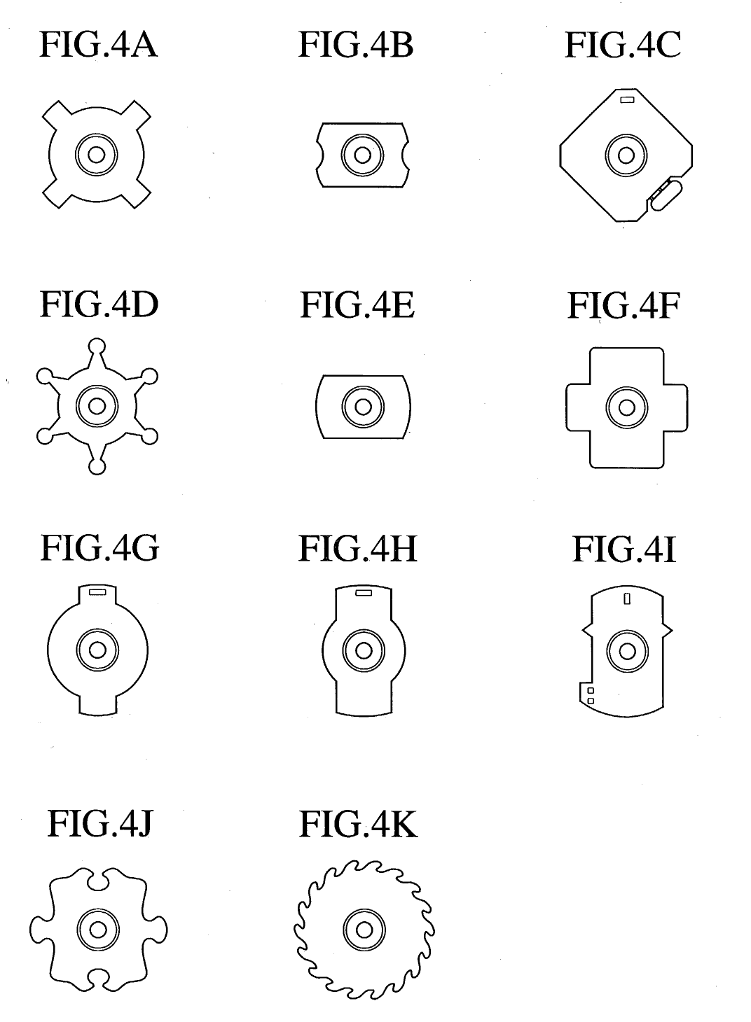

The machine readable section 16 can include any sort of machine readable media including but not limited to ROM memory, RAM memory, magnetic memory, a CD, a DVD, or a swipe card. The machine readable section 16 as shown in FIG. 1b can be on the back 12 of the event ticket 10. The machine readable section 16 can include any sort of machine readable media including a CD, DVD, MMC cards, compact flash storage and other machine readable storage types. Since the machine readable section 16 can include any sort of machine readable media, that media does not have to be a regular shape thus resulting in the event ticket capable of taking any number of shapes as shown later in FIGS. 4a-4k.

The static portion 18 includes read-only static data 22 relevant to the event, the static data 22 being accessible pre- or post-event. The static data 22 can include the validating data 17 discussed above. The static data 22 is data relevant to a potential ticket holder or related individuals, including, but not limited to event related information and is stored in any static format. Storage formats include printed formats, both analog and digital as well as a variety of forms such as audio, olfactory, or visual including holograms. This information can include directions to an event, advertisements, store fronts that link to a related web site, player statistics, historical information, background information, translations, pre-event entertainment opportunities, pre-game or performance interviews or predictions or challenges, video clips, and any other related information.

The dynamic portion 20 of the event ticket 10 can include a communication means 24. An example of the communication means 24 is a software or hardware placed on the machine readable section 16 that is capable of starting a browser when the event ticket 10 is loaded in a web-based system. An example of how this would work starts with the software that is activated when the machine-readable section 16 of the event ticket 10 contacts the reader. The communication means 24 would then place a URL (Uniform Resource Locator) in the browser, accessing the Internet and bringing up a screen. This screen would be capable of being updated independent of the event ticket 10 or simultaneously with the activation of the dynamic portion 20.

The dynamic portion 20 can be used to access an updated screen via the communication means 24 as described above allowing pre- and/or post-event communication with a browser. The dynamic portion 20 can include content similar to the static content that allows access to changeable content. The dynamic portion 20 can also includes modifiable data or capacity to acquire and retain machine-readable information after the event ticket 10 has been produced. The dynamic portion 20 can have read-write capability relevant to the event. The dynamic portion 20 includes content access to content that does or is changed or is changeable.

The dynamic portion 20 can link to any of the following content including event related information, directions to the event, a clip of the performance, a recording of the live performance, advertisements, store fronts that link to a related web site, event player statistics, post-game or performance interviews, video clips, advertisements, store fronts that link to the related web site, performance information, and post-event entertainment opportunities. The dynamic portion 20 is not limited to screens that contain the above content or to just screens in general.

The event ticket 10 may have a separable tab 30 affixed to the event ticket 10 including to the machine-readable section 16 of the ticket. The separable tab 30 may include validating data 17. The event ticket 10 may also have a collectable portion 32 and may contain a hologram 34. The collectable portion 32 can be combined with other items in ways that are well known to make a collectable item 35 such as a pin, button, or other souvenir. The ticket may easily be personalized with visual identification or machine-readable data.

Event ticket 10 content can include advertisements, team statistics, schedules, and venue information such as seat information, directions to the stadium and even a seat, snack food locations, merchandise booths, hotels, area sights (museums and locations of interest). Other content may include links to the city's web page and demography (date of stadium construction, seat capacity, largest crowds, and other statistics about the stadium and area).

The event ticket 10 can also include a media library with video clips, sound clips, photos and articles of the ticketed or related events. Additional content may include an event video and audio, printed highlights, advertising, an annual report, a catalogue, celebrity endorsements, collectors items, contest promotions, direct mail opportunities, educational material, event admissions, fundraising opportunities, applicable grand openings, holiday greetings, logo branding, media releases, merchandise information, product launch material, product samples, recording media, software media, testimonials, and a virtual art gallery. All of this content can be capable of being played in a standard audio CD-player or on a computer.

The event ticket 10 shown in FIG. 1a can include a ticket case 13 containing the second component 15 of the ticket 10 and/or also containing additional information relevant to the event or other information directed towards the consumer. The ticket case 13 may be a carrying case or part of a larger item and can actually include the first component 14 of the event ticket 10.

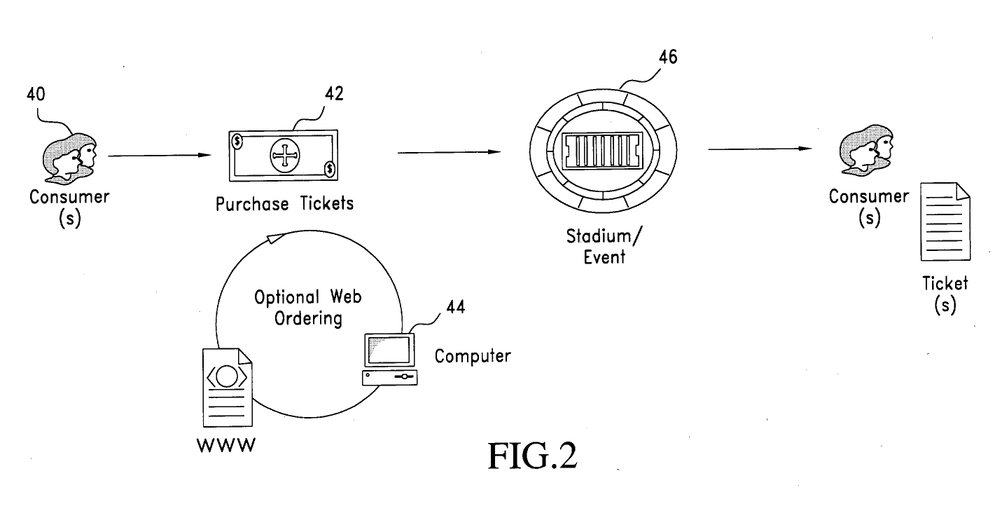

FIG. 2 represents the typical conventional sales method, as it would be used during the purchase of the ticket which can be an e-ticket, event ticket, travel ticket, or any other type of ticket. The ticket is sold when the customer 40 goes to a ticket sales window and decides what ticket he desires to purchase. When the customer purchases the paper or plastic ticket it is printed out by a dedicated printer for ticket printing or already available pre-printed. Usually the customer pays for the ticket at the ticket sales window. As shown in FIG. 2, a consumer 40 will normally purchase a ticket, such as a paper ticket 42 either in person or from a web page on a computer 44. The purchased ticket may be mailed to the consumer 40. The consumer 40 will then take this ticket 42 to the event 46 and present the ticket in order to gain admission.

Consumers 40 may keep the paper ticket 42 as a memento after they leave the event. The event entry and associated memories are the extent of the usefulness of the traditional plastic or paper ticket. The consumer may then paste the ticket 42 in a scrapbook or store the ticket someplace and will not refer to it again. Tickets are the one item that is guaranteed to get in the hand of the consumer 40 since it is presented at the event. The fact that consumers 40 may view these tickets as mementos means the traditional ticket is the one item that is guaranteed to stay the longest in the hand of the consumer 40 but the traditional ticket lacks the capability to be anything but an admission to an event. The traditional ticket represents a lost opportunity for direct marketing because of the limited space available for advertisements on the ticket.

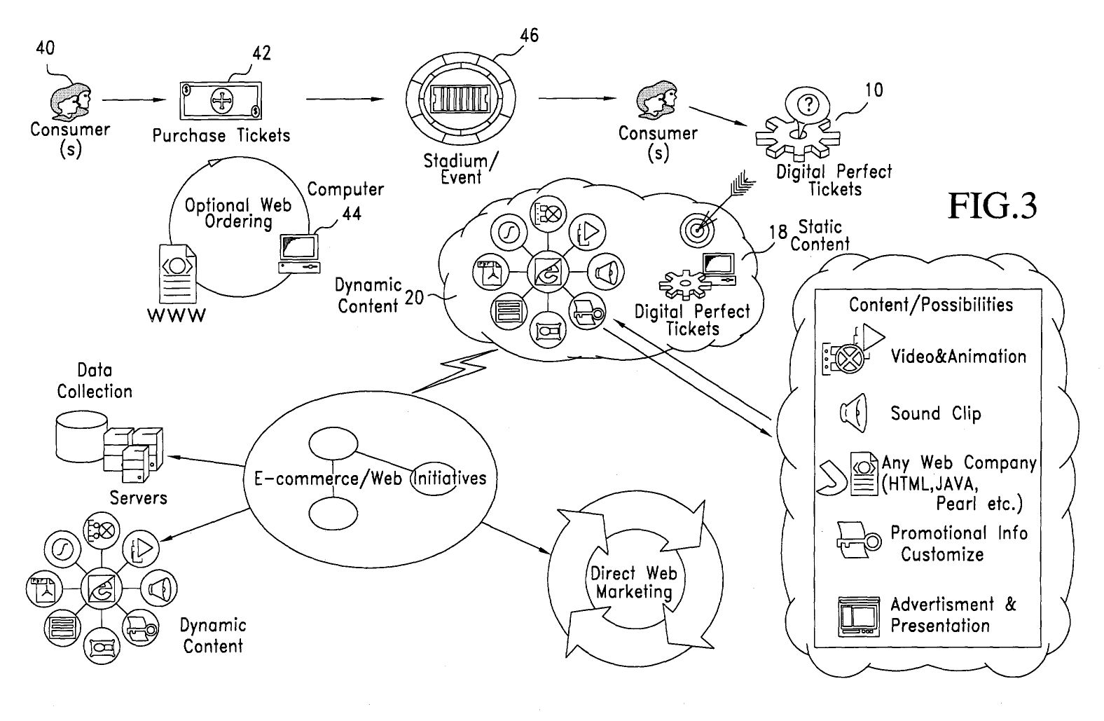

FIG. 3 shows the event ticket 10 of the present application. The static portion 18 of the event ticket 10 as described above can contain a number of event related items such as video including animation, sound clips, and other dynamic expressions in any web-compatible format such as HTML, JAVA, Pearl, etc. The static portion 18 can include promotional information, customized advertisement and customized presentations as discussed above. The present invention takes the standard plastic or paper ticket 42 and substitutes a machine-readable event ticket 10 that includes machine readable media, like digital media, capable of interfacing with companies so the companies can take advantage of the media to offer information and opportunities to the end user. This allows the event ticket 10 to be an interactive experience as well as a collector item.

The event ticket 10 includes machine-readable information, such as a CD or DVD, that can be put into a machine reader such as a CD player or computer to be read or played. The event ticket 10 demands attention from the consumer 40. Unlike printed material, the event ticket 10 can engage the consumer 40 with sound as well as visual effects. The event ticket 10 can deliver a dynamic sales presentation with narration, music, animated graphics, moving text, photographs and video clips.

The consumer is intrigued by the event ticket 10 and is interested in finding out what content is on the event ticket 10 even before the event. Thus the consumer will put the machine-readable media in an appropriate reader, such as the CD (in a PC or CD player), and run a presentation from the event ticket 10 to experience the available information about the event and discover additional included information. This is a positive experience for the consumer 40 and engages the consumer 40 in a number of ways, making the event ticket 10 both a promotional tool and conveyer of information. The event ticket 10 is much more likely to be reviewed by the consumer 40 since the event ticket 10 may have clips that relate to the event or other related information. This pre-event opportunity to communicate to an end-user and/or consumer is invaluable to a company, promoter, sponsor, the team or a performer as well as any one else connected to the event.

After the event takes place or after a predetermined period of time, if a time dependent component is available, the event ticket 10 can be transformed into a post event ticket. An example of the time-dependent component that could be used is an internal clock activated by the appropriate reader. The post-event transformation can be automatic, using self activating software for instance, or mechanical by an action such as putting the machine-readable media in an appropriate reader at the event or after the event, such as placing the event ticket CD in a PC.

This transformation allows post-event available information to be placed on the machine-readable media in the dynamic portion of the event ticket 10 or be made available via the dynamic portion of the event ticket 10. An example of such a transformation is when an updated screen is accessible via the communication means 24 on the dynamic portion of the event ticket 10 when the CD is loaded into a PC after the event and the end-user accesses the event related web-site. The post-event information could also be automatically available or accessible via an electronic reader at the event. This allows a range of valuable collection item to be available for free or for a surcharge.

FIGS. 4a-4k show a few of the formats that the event ticket 10 can take. The event ticket 10 can be small or of an intriguing shape, sometimes identifiable with the event to which the event ticket 10 relates. Such configurations make the ticket even more interesting and valuable to the consumer 40. The consumer 40 is intrigued by the thought of being able to watch an interactive presentation on the miniature or uniquely shaped CD, or other media because it has the appearance of being leading edge technology. The event ticket 10 is a cost-effective way to promote events, web sites, entertainers, sports teams and other events.

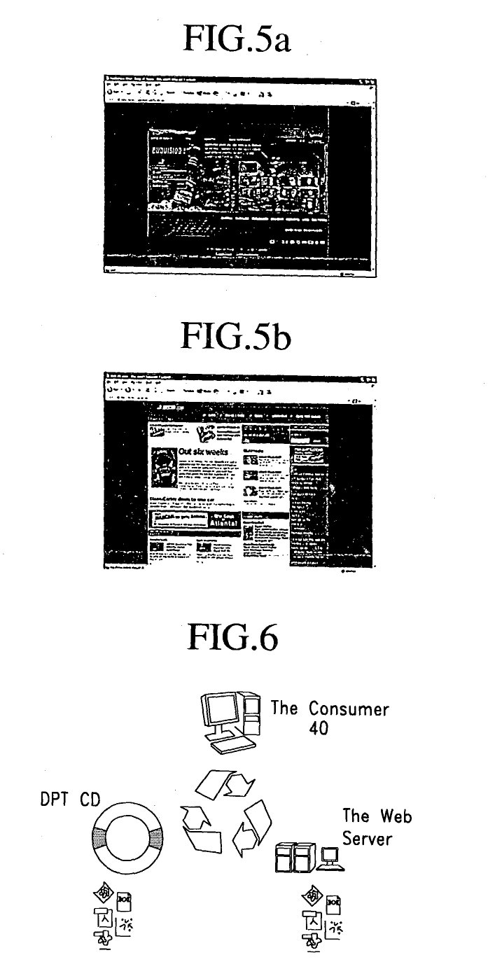

The web-compatible formats such as HTML, JAVA, PEARL, etc. can link to web sites as shown in FIG. 5, that exist on the Internet currently. These sites can represent an advertiser or include the event directions or access preexisting maps on the Internet. This allows the consumer 40 to visit an Internet site and make a purchase using links on the event ticket 10. This ability to make products readily available is a valuable tool for selling event-related sales of related merchandise. The event ticket 10 can also include application forms or other documents, full color sales brochure, audio or video testimonials from satisfied customers, a press release about additions to the product line, range of products that are related to the current event, or details of new services that are related to these event-related merchandise.

The event ticket 10 also allows a company to collect marketing information from the consumer 40, as shown in FIG. 6, when the consumer 40 logs on to the web site via the event ticket 10. Information can be captured by the visited website wherein the capture allows for an elaborate marketing plan to be implemented by using consumer data and habits of a particular population that would be going to an event and even could be customized to take advantage of the particular seat or group of seats that the consumer 40 has used in the event to customize the marketing approach and better allow collection of customized data from the consumer.

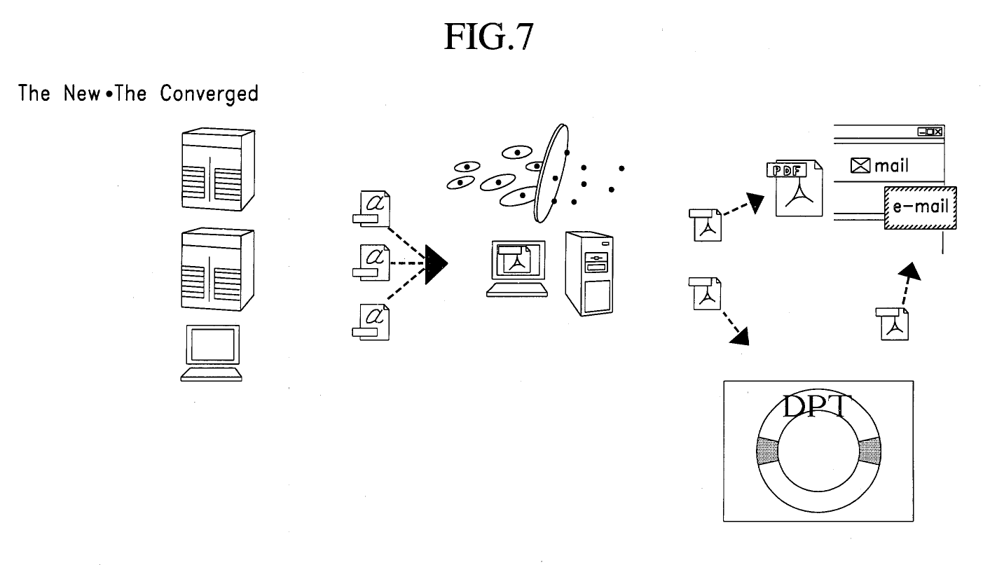

The post-event ticket 10 as shown in FIG. 7 of the current invention would be popular as a collectible item such as baseball cards or NASCAR driver cards that are currently available but with a far wider range of options. For example, carrying that particular ticket could allow the consumer to show support for a favorite driver, athlete or musician. Just the shape of indicia on the collectible ticket improves marketing and advertising if it is shared by others but the true value of the event ticket 10 is in the machine-readable and adaptable media. The interactive capabilities of the event ticket 10 can be utilized in advertising and marketing before and after an event.

Linking a sports team or advertiser's investments to an e-commerce area or other areas of the web can allow the exchange of information over a period of time, even daily or hourly. Another opportunity is that every time a consumer accesses a linked web page, the content provider is able to obtain other information to be used for marketing, using common sales techniques such as prize giving, drawings or other games. If the end-user or consumer 40 can win free items or has an opportunity to go back-stage at the event, these incentives increase the chances that the event-ticket 10 will be used to access the website before the event.

After the event, the web page or other sources of data can interact with the event ticket 10 to allow a summary of the performances or the sports data that were collected, to be accessed by the event ticket 10 or loaded onto the event ticket 10 for a lasting memento. Such data acquisition gives the event ticket 10 great value for the consumer and makes it collectible as a unique item. These post-event transactions could even include personal interviews or personalized interactions with performers or other attendees of the event through the use of data recording such as digital cameras and video recorders.

While the invention has been described with reference to preferred embodiments, those familiar with the art will understand that various changes may be made without departing from the scope of the invention. In addition, many modifications may be made to adapt a particular situation to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appending claims.

What is claimed:

1. An event ticket for use in gaining entry to an event comprising:
a) a first component;
b) a second component including a machine readable section having a static portion and a dynamic portion;
c) the static portion including read-only data relevant to the event, the data being accessible pre- or post-event; and
d) the dynamic portion including communication means allowing at least one of a pre- and post-event communication with a reader.

2. The event ticket of claim 1 wherein the reader is a browser.

3. The event ticket of claim 1 wherein the machine readable section includes an address on the Internet.

4. The event ticket of claim 1, further comprising:
(e) a separable tab affixed to the machine readable section.

5. The event ticket of claim 1, further comprising a collectable portion.

6. The event ticket of claim 1, further comprising a hologram on the event ticket.

7. The event ticket of claim 1 wherein the first component is capable of holding the second component.

8. The event ticket of claim 7 wherein validating data is on the first component.

9. The event ticket of claim 1, further comprising data validating a right to enter the event.

10. The event ticket of claim 9 wherein the validating data is on the machine-readable portion.

11. The event ticket of claim 1, the dynamic portion of the machine readable section being selectively modified by the user-initiated communication with the Internet.

12. The event ticket of claim 1, wherein the machine readable section comprises one of the following:
(a) ROM memory;
(b) RAM memory;
(c) magnetic memory;
(d) a CD;
(e) a DVD; and
(f) a swipe strip.

13. The event ticket of claim 1, wherein the static portion includes one of the following:
(a) event-related information;
(b) directions to the event;
(c) advertisements;
(d) links to a related web site;
(e) player statistics;
(f) historical information;
(g) background information;
(h) translations;
(i) pre-event entertainment opportunities;
(j) pre-game or performance interviews or predictions or challenges;
(k) video clips; and
(l) predetermined related information.

14. The event ticket of claim 1, wherein the dynamic portion includes a URL that can link to one of the following via the Internet:
(m) event-related information;
(n) directions to the event;
(o) a video or audio clip of a performance;
(p) a video or audio recording of the performance;
(q) advertisement;
(r) store fronts that link to the related web site;
(s) event player statistics;
(t) post-game or performance interviews;
(u) performance information; and
(v) post-event entertainment opportunities.

15. An event ticket for use in gaining entry to an event comprising:
a) a first component including data validating a right to enter and attend the event;
b) a second component including a machine readable section having a static portion and a dynamic portion;
c) the static portion including read-only data relevant to the event, the data being accessible pre- or post-event; and
d) the dynamic portion including communication means allowing at least one of a pre- and post-event communication with a browser.
